(19) United States
(12) Patent Application Publication
(10) Pub. No.: US 2004/0151156 A1
(43) Pub. Date: Aug. 5, 2004

(54) Method for using several logical channels for one radio bearer between mobile station and a network

(76) Inventors: Frederic Noel, Espoo (FI); Guillaume Sebire, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/477,319

(22) PCT Filed: May 7, 2002
(86) PCT No.: PCT/FI02/00387

(30) Foreign Application Priority Data
May 11, 2001 (FI) 20010998

(51) Int. Cl. H04J 3/24; H04L 12/28; H04L 12/56

(52) U.S. Cl. 370/349; 370/401

(57) ABSTRACT

Even with techniques increasing a basic transmission rate, i.e. a modulation method of the EDGE and usage of several basic traffic channels to form a high-speed traffic channel, the theoretical maximum data rate of a logical link, and thus of a radio bearer, is 473.8 kbits/s. That is, however, not sufficient for satisfying new requirements of up to 2 Mbits/s. The new requirements, and even higher data rates, can be achieved by having several simultaneous single carrier logical links (TBFs), and thus logical channels, for one radio bearer between a mobile station and a network. The number of supported carriers, and preferably also the maximum multicarrier allocation bandwidth, is indicated in a multicarrier class of a mobile station.

### FIELD OF THE INVENTION

The invention relates to high-speed connections in a mobile communication system, and particularly to high-speed connections between a mobile station and a GPRS/EDGE (General Packet Radio Service/Enhanced Data Rates for GSM Evolution) radio access network called GERAN.

### BACKGROUND OF THE INVENTION

The mobile communication system generally refers to any telecommunication system, which enables wireless communication when a user is located within the service area of the system. Examples of such systems are cellular mobile communication systems, such as the GSM (Global System for Mobile communications), or corresponding systems, such as the PCS (Personal Communication System) or the DCS 1800 (Digital Cellular System for 1800 MHz), third generation mobile systems, such as the UMTS (Universal Mobile Communication System) and systems based on the above mentioned systems, such as GSM 2+ systems and the future 4^{th} generation systems. One typical example of a mobile communication system is the public land mobile network PLMN.

While the mobile communication systems have evolved, also services provided via the mobile communication systems have been under development. Due to new services, the need for high-speed data has grown, since one of the main objectives of the development is to provide a possibility to use IP (Internet Protocol) services through the mobile system. One of the bottlenecks for high-speed traffic is the present protocol architecture of a data link layer, also called layer 2 via which a radio bearer is established between a mobile station and the radio access network. One mobile station can have several simultaneous independent radio bearers with various quality of service classes, etc. However, one radio bearer can have at most one carrier, one logical link (called a Temporary Block Flow TBF in the GERAN) and one logical channel. Even with techniques increasing a basic transmission rate, i.e. a modulation method of the EDGE and usage of several basic traffic channels to form a high-speed traffic channel, the theoretical maximum data rate of a logical link, and thus of a radio bearer, is 473.8 kbits/s. That is, however, not sufficient for satisfying new requirements of up to 2 Mbits/s.

### BRIEF DESCRIPTION OF THE INVENTION

An object of the present invention is to provide a method, a communication system and a mobile station for implementing the method so as to increase the transmission rate of a radio bearer. The object of the invention is achieved by a method, a communication system and a mobile station which are characterized by what is stated in the independent claims. The preferred embodiments of the invention are disclosed in the dependent claims.

The invention is based on the idea of having several simultaneous single carrier logical links (TBFs), and thus logical channels, for a radio bearer between a mobile station and a network.

### BRIEF DESCRIPTION OF THE DRAWINGS

In the following the invention will be described in greater detail by means of preferred embodiments with reference to the attached drawings, in which

FIG. 1 illustrates basic parts of a communication system;

FIG. 2 shows a protocol architecture according to a first preferred embodiment of the invention;

FIG. 3 shows a protocol architecture according to a second preferred embodiment of the invention; and

FIG. 4 illustrates signalling according to the first preferred embodiment of the invention.

### DETAILED DESCRIPTION OF THE INVENTION

The present invention can be applied to any communication system providing high-speed data over the air interface. Such systems include the above mentioned systems, for example. In the following the invention will be described by using a GERAN system as an example without restricting the invention thereto.

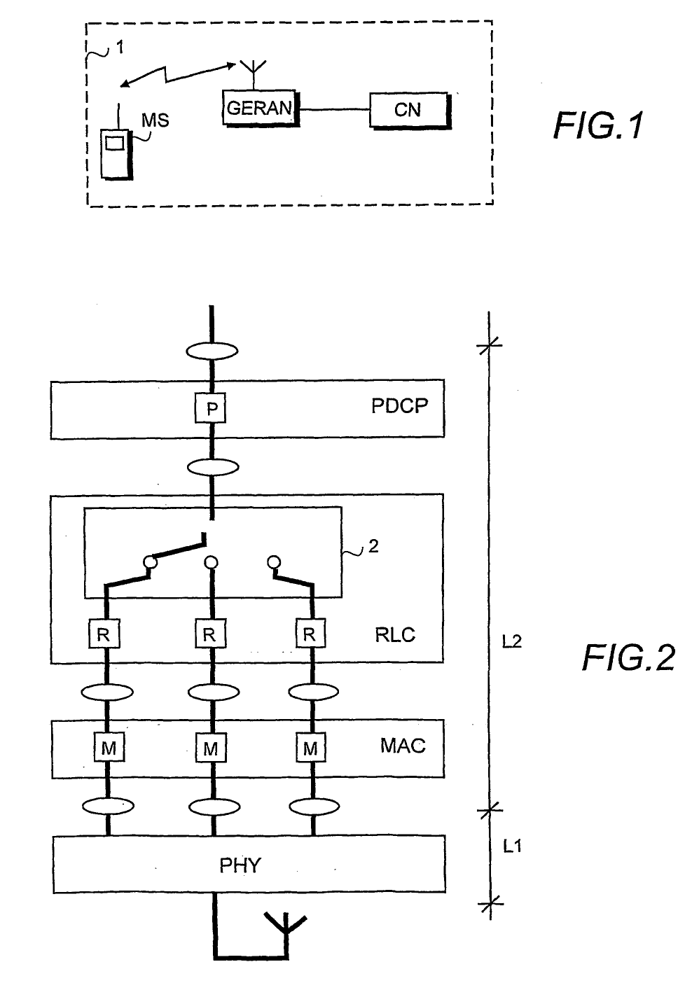

FIG. 1 shows a very simplified network architecture illustrating only basic parts of the communication system 1. It is obvious to a person skilled in the art that the system 1 comprises network nodes, functions and structures, which need not be described in greater detail here.

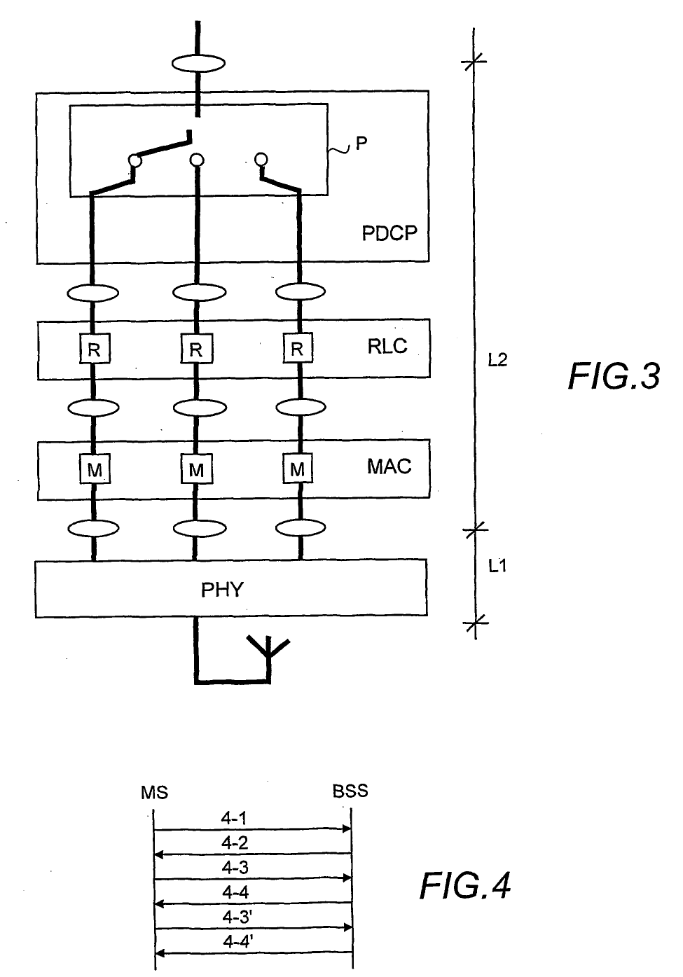

A mobile station MS comprises the actual terminal and a detachably connected identification card SIM, also called a subscriber identity module. In this context, the mobile station generally means the entity formed by the subscriber identity module and the actual terminal. The SIM is a smart card which comprises subscriber identity, performs authentication algorithms and stores authentication and cipher keys and subscription information necessary for the user equipment. The actual terminal of the invention can be any equipment capable of communicating in a mobile communication system and supporting multicarrier access so that it can at least inform the network about multicarrier capabilities of the terminal as described later especially with FIG. 4. The terminal of the invention may also support either of the protocol architectures illustrated in FIGS. 2 and 3. The terminal can thus be a simple terminal intended only for speech, or it can be a terminal for various services, operating as a service platform and supporting the loading and carrying out of different service-related functions. The terminal can also be a combination of various devices, for example a multimedia computer with a Nokia card phone connected to it to provide a mobile connection. The inventive functionality of the terminal or part of it may also be performed by the SIM. However, mobile stations not supporting any of the inventive functionality/features may be used in a communication system according to the invention.

In the example of FIG. 1, the system 1 comprises a core network CN and a radio access network GERAN. The GERAN is formed of a group of radio network subsystems (not shown in FIG. 1), such as base station subsystems of GSM, which are connected to the core network CN via a so-called lu-interface 2. The GERAN may be a GSM/EDGE Radio Access Network and the CN may be a GSM/UMTS core network.

FIG. 2 shows a radio interface protocol architecture of a user plane according to the first preferred embodiment of the invention. The corresponding layers and/or sub-layers implemented according to the first preferred embodiment of the invention may be used in a control plane and/or other interfaces, too. The thick lines between layers and sub-layers illustrate possible data flows, squares illustrate instances of a respective protocol and circles illustrate service access points for peer-to-peer communication.

The radio interface protocol architecture illustrated in FIG. 2 comprises a physical layer L1 and a data link layer L2. The data link layer L2 comprises following sub-layers: the Packet Data Convergence Protocol PDCP, the radio link control RLC and the medium access control MAC.

The PDCP provides upper layers with data transfer, i.e. PDCP SDU (Service Data Unit) delivery either in a transparent mode or a non-transparent mode. In the transparent mode the PDCP layer does not change the incoming SDUs, i.e. no header is added to an SDU and possible existing headers of upper layers in the SDU are left untouched. In the non-transparent mode the PDCP may adapt the existing header by removing it or by compressing it.

The RLC provides the upper layer among other things transparent, acknowledged or unacknowledged data transfer. The RLC according to the first preferred embodiment of the invention comprises for various RLC instances a common RCL SDU buffer with a demux 2 which buffers and demultiplexs SDUs, i.e. buffers and splits the higher speed user data to several RLC instances R. The RLC will preferably create an RLC instance R to each carrier of a radio bearer.

The MAC provides each RLC instance with a corresponding logical link, TBF, and handles the access to and multiplexing onto the physical subchannels thus defining among other things logical channels to be used.

FIG. 3 illustrates the second preferred embodiment of the invention, which differs from the first one in the aspect that the demuxing is performed in the PDCP. One radio bearer has one PDCP instance P. Each PDCP instance comprises a PDU buffer with a demux which demultiplexs packet data units of the PDCP instance to an available RLC instance dedicated to a carrier. Each RLC instance is an independent instance transferring the data flow to MAC according to the standard. The MAC of the second preferred embodiment of the invention does not differ from the MAC of the first preferred embodiment of the invention described above.

Both of the above described architectures enable an MS to use several single carrier TBFs between its PDCP instance and its physical layer, per radio bearer and per direction, i.e. uplink and downlink.

In the first preferred embodiment of the invention a multicarrier class for a mobile station is defined, the multicarrier class comprising two different pieces of information, namely a maximum number of carriers for a radio bearer that the MS supports and a maximum multicarrier allocation bandwidth. In the first preferred embodiment of the invention the maximum number of carriers can be anything between 1 and 8 carriers and thus it can be coded on 3 bits. In the first preferred embodiment of the invention the maximum multicarrier allocation bandwidth, coded on 5 bits, can be anything between 1 to 32 times the carrier width, which in the GSM/EDGE is 200 kHz. Thus the multicarrier class is coded on 8 bits (1 octet) in the first preferred embodiment of the invention. In other embodiments of the invention the multicarrier class may comprise only one of the above mentioned pieces of information, and/or some additional information. The length of the multicarrier class or the pieces of information may be different from the above mentioned 8, 3 and 5 bits.

Since there are different mobile stations having different kinds of multicarrier classes, e.g. from single carrier mobile stations to 8 carrier mobile stations, the network needs to be informed on the multicarrier class of the mobile station. The multicarrier class of the mobile station is preferably transferred in a radio access capability information element (RAC IE) formed by the mobile station for providing the network, and especially the radio access part of the network, such as a BSS (Base Station Subsystem) serving the mobile station, with information on radio aspects of the mobile station. The multicarrier class may be added in the RAC IE just before the multislot capability information, for example. Instead of the actual multicarrier class, such as the 8 bit code of the first preferred embodiment of the invention, an indication of the multicarrier class may be used. If the indication is used, then on the network side, data for interpreting the indication to a corresponding actual multicarrier class has to be maintained.

FIG. 4 illustrates access signalling in the first preferred embodiment of the invention, where the mobile station adds its multicarrier class to the RAC IE. In the first preferred embodiment of the invention, the size of signalling messages is limited and the RAC IE is longer than the allowed maximum content length. For clarity's sake, it is assumed in FIG. 4 that the RAC IE is not twice as long as the allowed maximum content length.

Referring to FIG. 4, the MS sends a packet channel request (message 4-1) to the BSS serving the MS. The request may be triggered by the user of the MS or in response to paging, for example. The packet channel request (message 4-1) is sent on a PRACH (packet random access channel) and the BSS responds by sending a packet uplink assignment (message 4-2) on a PAGCH (packet access grant channel). In response to message 4-2 the MS of the first preferred embodiment of the invention splits the RAC IE into two parts, the first part comprising information needed to establish a single carrier for a radio bearer, and the second part comprising rest of the RAC IE. In the first preferred embodiment of the invention the second part comprises only the multicarrier class, since it was the only new element added to a RAC IE of prior art not exceeding the allowed maximum content length. When the RAC IE is split, the MS sends packet resource request (message 4-3) comprising the first part of the RAC on a PACCH (Packet Associated Control Channel). In response to message 4-3 the BSS allocates a radio bearer and a carrier for the radio bearer, establishes a TBF for the radio bearer and sends a packet uplink assignment (message 4-4) on PACCH. Now data can be transmitted on the established single TBF, i.e. logical link. Then the MS of the first preferred embodiment of the invention sends the second part of the RAC IE, i.e. the multicarrier class of the MS, in another packet resource request (message 4-3′) on the PACCH. The second part of the RAC IE is preferably sent before any data is send on a PDTCH (Packet Data Traffic Channel). Only after receiving the latter packet resource request (message 4-3′) are the radio access capabilities of the MS are completely known by the BSS and the BSS may establish additional single carrier TBFs for the same radio bearer according to the multicarrier class of the MS. After establishing one or more additional single carrier TBFs the BSS sends a packet uplink assignment (message 4-4′) indicating multicarrier allocation. Then the multicarrier data transfer on the PDTCH can take place.

The signalling of messages 4-1 to 4-4 illustrates a prior art method called two-phase access method, and thus the signalling illustrated in FIG. 4 can be called three-phase access method.

In other embodiments of the invention the RAC IE may be split into several parts, one of the parts comprising at least the multicarrier class. Preferably, the contents of different parts do not overlap.

The signalling messages shown in FIG. 4 and related functions described above are not in absolute chronological order and they can be carried out in the order different from the given one. Other signalling messages can be transmitted and/or other functions can also be carried out between the messages and/or functions, such as an optional additional radio access capabilities' message according to prior art after the message 4-3 before message 4-4. The signalling messages are only examples and may also comprise other information. Furthermore, the messages may be different from the above-mentioned messages. The messages may also be transmitted on channels other than the ones stated above. For example, the MS sends RAC IE in an attach request when the MS is initiating an attach procedure.

The signalling of FIG. 4 illustrates an idea of sending first data needed to establish the basic connection and after the establishment of the basic connection further data to amend the connection to have properties actually needed and/or supported. In other words, from one information element, the size of which is bigger than a payload for this information element in a signalling message sent over the interface, two or more sub-elements are formed, the first sub-element comprising at least the minimum information needed for creating a connection and the other sub-element(s) comprising additional information, and each of these sub-elements is sent as a payload of a signalling message used in prior art to transfer at least the basic information. The sub-elements are preferably sent in successive signalling messages so that a new signalling message is sent after a response for the previous one has been received. When all of these sub-elements have been transmitted, the needed/required resources can be allocated. It is obvious to one skilled in the art that this idea can be implemented with procedures other than the access procedure, such as the attach procedure, for example.

In addition to prior art means, the system implementing the functions of the present invention, the mobile stations and the network nodes of this system comprise means for providing more than one carrier for one radio bearer over the air interface. More precisely, the network nodes and/or the mobile station may comprise means for implementing at least one of the functions/features described above, the main functions being a multiplexing function preferably with a buffer, defining a multicarrier class to a mobile station, indicating the multicarrier class, and forming from one information element smaller sub-elements as described with FIG. 4. The current network nodes and mobile stations comprise processors and memory, which can be utilized in the functions according to the invention. All changes necessary for implementing the invention can be made as added or updated software routines, by means of application-specific integrated circuits (ASIC) and/or programmable circuits, such as EPLD, FPGA.

Although the invention has been described above with a radio interface, it is obvious to one skilled in the art that similar functionality may be applied to other air interfaces, such as an infrared interface, for example.

It will be obvious to a person skilled in the art that, as the technology advances, the inventive concept can be implemented in various ways. The invention and its embodiments are not limited to the examples described above but may vary within the scope of the claims.

1. A method for high-speed data transmission in a wireless communication system comprising at least a mobile station and a network, the method comprising the steps of:
allocating a wireless bearer for a connection between the mobile station and the network;
characterized by
using at least two logical links for the wireless bearer.

2. A method for high-speed data transmission in a wireless communication system, characterized by the method comprising the steps of:
defining a multicarrier class indicating at least how many carriers for a wireless bearer a mobile station can have at most; and
utilizing the multicarrier class of the mobile station when allocating resources for the mobile station.

3. A method according to claim 2, characterized by the multicarrier class indicating also the maximum multicarrier allocation bandwidth.

4. A method for high-speed data transmission in a wireless communication system, characterized by the method comprising the steps of:
defining a multicarrier class indicating at least the maximum multicarrier allocation bandwidth for a wireless bearer a mobile station can have; and
utilizing the multicarrier class of the mobile station when allocating resources for the mobile station.

5. A method for high-speed data transmission in a data link layer in a wireless communication system, characterized by the method comprising the steps of:
buffering a data flow from an upper layer in the data link layer; and
demultiplexing the data flow in the data link layer.

6. A method according to claim 5, characterized by performing the buffering and demultiplexing in a packet data convergence protocol sub-layer of the data link layer.

7. A method according to claim 5, characterized by performing the buffering and demultiplexing in a radio link control sub-layer of the data link layer.

8. A method in a wireless communication system comprising at least an access network and a mobile station, characterized by the method comprising the steps of:
forming a first element comprising information on wireless access capabilities of the mobile station;
forming from the first element at least two sub-elements, the size of which is smaller than a payload reserved for the first element in a request message, so that the first sub-element comprises at least basic information on the wireless access capabilities;
sending a first request message comprising the first sub-element from the mobile station to the access network; and
sending the other sub-elements in successive request messages.

9. A method according to claim 8, characterized by sending the other sub-elements in successive request messages after receiving a response to the first request message.

10. A method according to claim 8 or 9, characterized by forming the sub-elements when the size of the first element is bigger than the payload reserved for it in the request message.

11. A method for high-speed data transmission in a wireless communication system, characterized by the method comprising the steps of:
defining for a mobile station a wireless access capability information element comprising a multicarrier class indicating at least how many carriers for the wireless bearer the mobile station can have at most;
sending a first request comprising at least basic parts of the wireless access capability information element;
allocating a wireless bearer with a carrier for the mobile station on the basis of the first request;
sending another request comprising at least the multicarrier class of the wireless access capability information element; and
allocating for the wireless bearer more carriers so that the total number of carriers for the bearer is at most the number of carriers indicated by the multicarrier class, if the multicarrier class indicates more than one carrier for a wireless bearer.

12. A wireless communication system comprising at least
a mobile station,
a network,
a first allocator to allocate a wireless bearer for a connection between the mobile station and the network,
characterized in that the system further comprises at least
a second allocator to allocate for the bearer at least two carriers, and
a demux to demuxing a data flow sent via the bearer to the carriers of the bearer.

13. A mobile station in a wireless communication system, characterized in that it comprises
memory for storing a multicarrier class of the mobile station, the multicarrier class indicating at least how many logical links for a wireless bearer the mobile station can have at most; and
a transmitter to transmit the multicarrier class to a network of the wireless communication system.
